(19) United States
(12) Patent Application Publication
(10) Pub. No.: US 2025/0271672 A1
(43) Pub. Date: Aug. 28, 2025

(54) HEAD-MOUNTABLE DEVICE WITH GUIDANCE FEATURES

(71) Applicant: Apple Inc., Cupertino, CA (US)

(72) Inventors: Scott M. LEINWEBER, Sunnyvale, CA (US); John CAGLE, San Jose, CA (US); John S. CAMP, Los Gatos, CA (US); Paul X. WANG, Cupertino, CA (US); Denise R. CRUISE, Campbell, CA (US)

(21) Appl. No.: 18/857,154

(22) PCT Filed: Jun. 9, 2023
(86) PCT No.: PCT/US2023/025004

§ 371 Date: Oct. 15, 2024

Related U.S. Application Data
(60) Provisional application No. 63/351,760, filed on Jun. 13, 2022.

(51) Int. Cl. G02B 27/01; G06F 3/01; G06F 3/16

(52) U.S. Cl. CPC G02B 27/0172; G02B 27/0179; G06F 3/012; G06F 3/013; G06F 3/016; G06F 3/167; G02B 2027/0138; G02B 2027/014; G02B 2027/0187

(57) ABSTRACT

A head-mountable device can facilitate comfort, guidance, and alertness of the user by providing visual and other outputs with one or more user interface devices. Such outputs can encourage awareness, alertness, and knowledge of the user's movement, features of the environment, and/or the conditions of the user. The actions can be performed by an output of the head-mountable device, such as a display, a speaker, a haptic feedback device, and/or another output device that interacts with the user.

### CROSS-REFERENCE TO RELATED APPLICATIONS

The present application claims the benefit of U.S. Provisional Patent Application Ser. No. 63/351,760, entitled “HEAD-MOUNTABLE DEVICE WITH GUIDANCE FEATURES,” filed Jun. 13, 2022, which is hereby incorporated herein by reference in its entirety and made part of the present U.S. Utility Patent Application for all purposes.

### TECHNICAL FIELD

The present description relates generally to head-mountable devices, and, more particularly, to head-mountable devices that guide and direct a user during interactions.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a top view of a head-mountable device worn by a user, according to some embodiments of the present disclosure.

FIG. 3 illustrates a view of a head-mountable device worn by a user, according to some embodiments of the present disclosure.

FIG. 4 illustrates a flow diagram of an example process for operating a head-mountable device to detect and respond to features of the environment and/or movement of the user, according to some embodiments of the present disclosure.

FIG. 5 illustrates a flow diagram of an example process for operating a head-mountable device based on a profile of a user, according to some embodiments of the present disclosure.

FIG. 6 illustrates a view of a head-mountable device providing a user interface, according to some embodiments of the present disclosure.

FIG. 7 illustrates a view of the head-mountable device of FIG. 6 providing a user interface with a modified output, according to some embodiments of the present disclosure.

FIG. 8 illustrates a view of the head-mountable device of FIG. 6 providing the user interface with a modified visual feature, according to some embodiments of the present disclosure.

FIG. 9 illustrates a view of the head-mountable device of FIG. 6 providing the user interface with a modified visual feature, according to some embodiments of the present disclosure.

FIG. 10 illustrates a view of a head-mountable device of FIG. 6 providing the user interface with an indicator, according to some embodiments of the present disclosure.

FIG. 11 illustrates a view of a head-mountable device of FIG. 6 providing the user interface and other output, according to some embodiments of the present disclosure.

FIG. 12 conceptually illustrates a head-mountable device with which aspects of the subject technology may be implemented in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. The head-mountable device can provide a user experience that is immersive or otherwise natural so the user can easily focus on enjoying the experience without being distracted by the mechanisms of the head-mountable device.

In some uses, it can be desirable to increase a user's comfort and convenience while wearing and/or operating a head-mountable device. For example, a head-mountable device may facilitate and/or enhance a user's awareness and/or rection to various conditions that can be detected by the head-mountable device. Such conditions can include features and/or events in an environment of the user, motion of the user and/or the head-mountable device, and/or detected activities of the user. By making such detections and providing appropriate outputs, the head-mountable device can facilitate and/or encourage the performance of actions by the user that enhance the user's comfort and/or awareness.

A head-mountable device can facilitate comfort, guidance, and alertness of the user by providing visual and other outputs with one or more user interface devices. Such outputs can encourage awareness, alertness, and knowledge of the user's movement, features of the environment, and/or the conditions of the user. The actions can be performed by an output of the head-mountable device, such as a display, a speaker, a haptic feedback device, and/or another output device that interacts with the user.

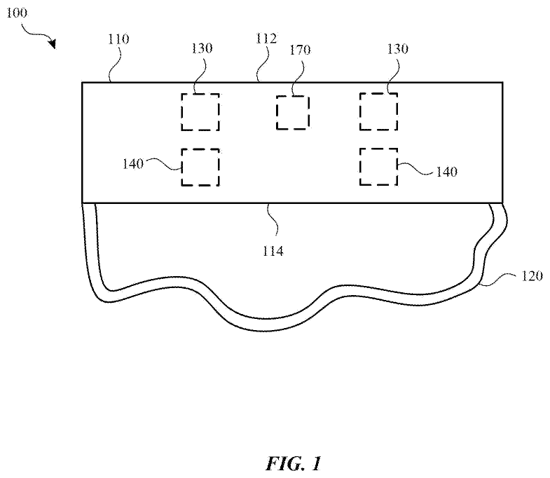

These and other embodiments are discussed below with reference to FIGS. 1-11. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 that is worn on a head of a user. The frame 110 can be positioned in front of the eyes of a user to provide information within a field of view of the user. The frame 110 can provide nose pads or another feature to rest on a user's nose. The frame 110 can be supported on a user's head with the head engager 120. The head engager 120 can wrap or extend along opposing sides of a user's head. The head engager 120 can include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. Any number of components can be included within and/or on the frame 110 and/or the head engager 120.

The frame 110 can include and/or support one or more cameras 130 and/or other sensors. The cameras 130 can be positioned on or near an outer side 112 of the frame 110 to capture images of views external to the head-mountable device 100. As used herein, an outer side 112 of a portion of a head-mountable device is a side that faces away from the user and/or towards an external environment. The captured images can be used for display to the user or stored for any other purpose.

It will be understood that the camera 130 can be one of a variety of input devices provided by the head-mountable device. Such input devices can include, for example, depth sensors, optical sensors, microphones, user input devices, user sensors, and the like, as described further herein.

The head-mountable device can be provided with one or more displays 140 that provide visual output for viewing by a user wearing the head-mountable device. As shown in FIG. 1, one or more optical assemblies containing displays 140 can be positioned on an inner side 114 of the frame 110. As used herein, an inner side of a portion of a head-mountable device is a side that faces toward the user and/or away from the external environment. For example, a pair of optical assemblies can be provided, where each optical assembly is movably positioned to be within the field of view of each of a user's two eyes. Each optical assembly can be adjusted to align with a corresponding eye of the user. Movement of each of the optical assemblies can match movement of a corresponding camera 130. Accordingly, the optical assembly is able to accurately reproduce, simulate, or augment a view based on a view captured by the camera 130 with an alignment that corresponds to the view that the user would have naturally without the head-mountable device 100.

A display 140 can transmit light from a physical environment (e.g., as captured by a camera) for viewing by the user. Such a display can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

It will be understood that the display 140 can be one of a variety of output devices provided by the head-mountable device. Such output devices can include, for example, speakers, haptic feedback devices, and the like.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations, (e.g., for accessibility reasons), adjustments to characteristic(s) of virtual object(s) in a CGR environment may be made in response to representations of physical motions (e.g., vocal commands).

There are many different types of electronic systems that enable a person to sense and/or interact with various CGR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld processors with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Referring again to FIG. 1, the head-mountable device can include a user sensor 170 for detecting a condition of a user, such as a condition of the user's eyes. Such a condition can include eyelid 24 status (e.g., open, closed, partially open or closed, etc.), blinking, eye gaze direction, moisture condition, and the like. The user sensor 170 can be further configured to detect other conditions of the user, as described further herein. Such detected conditions can be applied as a basis for performing certain operations, as described further herein.

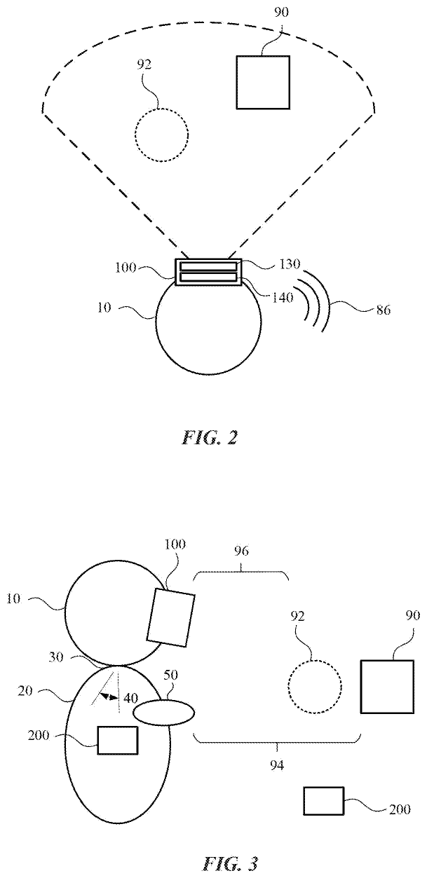

Referring now to FIGS. 2 and 3, the user can operate the head-mountable device, and the head-mountable device can make detections with regarding to the environment, the head-mountable device itself, and/or the user. Such detections can provide a basis for performing certain operations by the head-mountable device, such as providing outputs to the user.

FIG. 2 illustrates a top view of a head-mountable device in use by a user, according to some embodiments of the present disclosure. As shown in FIG. 2, the head-mountable device 100 can include one or more sensors, such as a camera 130, optical sensors, and/or other image sensors for detecting features of an environment, such as physical features 90 of the environment within a field of view of the camera 130 and/or another sensor. Additionally or alternatively, a camera 130 can capture and/or process an image based on one or more of hue space, brightness, color space, luminosity, and the like. In some embodiments, the sensor can include a depth sensor, a thermal (e.g., infrared) sensor, and the like. For example, a depth sensor can be configured to measure a distance (e.g., range) to a feature (e.g., region of the user's face, user's body portion, and/or feature or object of the environment) via stereo triangulation, structured light, time-of-flight, interferometry, and the like.

By further example, the sensor can include a microphone for detecting sounds 86 from the environment and/or from the user. It will be understood that physical features 90 in an environment of the user may not be within a field of view of the user and/or a camera 130 of the head-mountable device 100. However, sounds can provide an indication that the physical feature 90 is nearby, whether or not the physical feature 90 is within a field of view of the user and/or a camera 130 of the head-mountable device 100.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on.

The head-mountable device 100 can include an inertial measurement unit (“IMU”) as a sensor that provides information regarding a characteristic of the head-mountable device 100, such as inertial angles thereof. Such information can be correlated with the user, who is wearing the head-mountable device 100. For example, the IMU can include a six-degrees of freedom IMU that calculates the head-mountable device's position, velocity, and/or acceleration based on six degrees of freedom (x, y, z, θx, θy, and θz). The IMU can include one or more of an accelerometer, a gyroscope, and/or a magnetometer. Additionally or alternatively, the head-mountable device 100 can detect motion characteristics of the head-mountable device 100 with one or more other motion sensors, such as an accelerometer, a gyroscope, a global positioning sensor, a tilt sensor, and so on for detecting movement and acceleration of the head-mountable device 100. Such detections can provide a basis for performing certain operations by the head-mountable device, such as providing outputs to the user. For example, outputs can be provided to guide the user's future actions in response to detected movements and/or to verify that the user is alert and/or aware of the detected movements, for example by detecting a user condition that indicates whether or not the user has shown awareness of the movement (e.g., by corresponding action in response).

As shown in FIG. 3, the head-mountable device 100 can be worn on a head 10 of the user. The head 10 of the user can form an angle 40 with respect to the torso 20 or another body portion of the user. For example, the user can pivot the head 10 at the neck 30 to adjust the angle 40. It will be understood that the body portions for comparison can be any two or more body portions.

The head-mountable device 100 can be operated independently and/or in concert with one or more external devices 200. For example, an external device 200 can be worn on the torso 20 or other body portion of the user. By further example, an external device 200 can be one that is not worn by the user, but is otherwise positioned in a vicinity of the user and/or the head-mountable device 100. The head-mountable device 100 and/or the one or more external devices 200 can monitor their own conditions and/or conditions of each other and/or the user.

The head-mountable device 100 can provide a view of a physical feature 90 and/or a virtual feature 92 as a visual output to the user. It will be understood that the view can correspond to an image captured by a camera of the head-mountable device 100. Additionally or alternatively, the view can include virtual features that may or may not correspond to physical features of the physical environment.

The head-mountable device 100 can detect a proximity to the physical feature 90 and/or the virtual feature 92. For example, the head-mountable device 100 (e.g., independently and/or with the external device 200), can detect a distance 94 from a physical feature 90 to a limb 50 or other body portion of the user. Such detections can include detection of a position of the limb 50 or other body portion as well as detection of a position of the physical feature 90. Such detections can be made with a camera, depth sensor, or other sensor of the head-mountable device 100 and/or the external device 200 that detect both the physical feature 90 and the limb 50 or other body portion of the user.

By further example, the head-mountable device 100 (e.g., independently and/or with the external device 200), can detect a distance 96 from a virtual feature 92 to a limb 50 or other body portion of the user. Such detections can include detection of a position of the limb 50 or other body portion as well as detection of a position of the physical feature 90. Such detections can be made with a camera, depth sensor, or other sensor of the head-mountable device 100 and/or the external device 200 that detect the limb 50 or other body portion of the user. The detection of the virtual feature 92 may be known based on the generation thereof by the head-mountable device 100.

The detection of a physical feature 90 and/or a virtual feature 92 having a position and/or orientation with respect to the user (e.g., limb 50 or other body portion) and/or the head-mountable device 100 can provide a basis for providing outputs to the user. For example, outputs can be provided to guide the user's movements with respect to the physical feature 90 and/or the virtual feature 92 and/or to verify that the user is alert and/or aware of the physical feature 90, for example by detecting a user condition that indicates whether or not the user has shown awareness of the physical feature 90 (e.g., by corresponding action in response) and/or an intent to attempt interaction with the virtual feature 92. Other detected conditions, such as the user's gaze direction and/or velocity can provide further bases for determining whether an output is to be provided. Any given detection can be compared to one or more criteria (e.g., thresholds and the like) to determine what corresponding operation should be performed. While various detections are described herein, it will be understood that any one or more combination of detections can be applied. For example, a preliminary detection can be considered, and on that basis a secondary or other additional detection(s) can be considered to determine whether an operation should be performed. Accordingly, any number of detections, including any of those described herein, can be applied in serial or in parallel to determine whether an operation is to be performed. Any additional detection(s) can be applied to override a determination to perform an operation based on a preliminary detection.

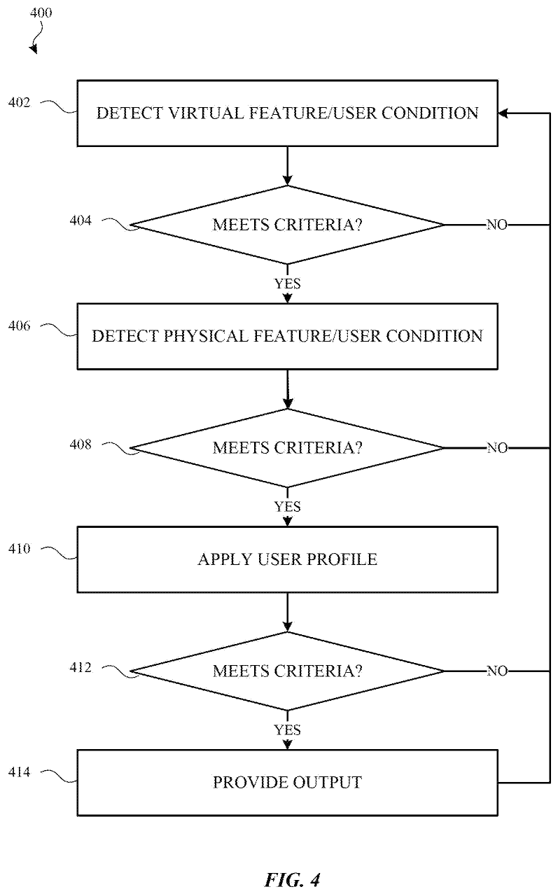

FIG. 4 illustrates a flow diagram of an example process for operating a head-mountable device to detect and respond to features of the environment and/or movement of the user, according to some embodiments of the present disclosure. For explanatory purposes, the process 400 is primarily described herein with reference to the head-mountable device 100 of FIGS. 2 and 3. However, the process 400 is not limited to the head-mountable device 100 of FIGS. 2 and 3, and one or more blocks (or operations) of the process 400 may be performed by one or more other components or chips of the head-mountable device 100 and/or another device (e.g., the external device 200). The head-mountable device 100 also is presented as an exemplary device and the operations described herein may be performed by any suitable device. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In operation 402, a head-mountable device can detect a virtual feature and/or the user's position and/or movement respect to the virtual feature. Such detections can be performed by one or more sensors of the head-mountable device and/or an external device.

In operation 404, detections made by one or more sensors can be compared to criteria to determine whether further operations are to be performed. For example, a detected condition of a virtual feature, a user, and/or the head-mountable device can be compared to a threshold, range, or other value to determine whether a response to the detection should be provided. By further example, a distance between a user (e.g., limb or other body portion) and a virtual feature can be detected and compared to determine whether it is within a range of interest. If the detected condition does not meet the criteria, then a further response may be omitted and/or additional detections can be made by returning to operation 402.

In operation 406, a head-mountable device can detect a physical feature in an environment of the user and/or the user's position and/or movement respect to the physical feature and/or the environment. Such detections can be performed by one or more sensors of the head-mountable device and/or an external device.

In some embodiments, additional detections and criteria can be applied. In operation 408, detections made by one or more sensors can be compared to criteria to determine whether further operations are to be performed. For example, a detected condition of a physical feature of the environment, a user, and/or the head-mountable device can be compared to a threshold, range, or other value to determine whether a response to the detection should be provided. By further example, a distance between a user (e.g., limb or other body portion) and a physical feature can be detected and compared to determine whether it is within a range of interest. If the detected condition does not meet the criteria, then a further response may be omitted and/or additional detections can be made by returning to operation 402 and/or operation 406.

It will be understood that, in some embodiments, other detections and criteria can be applied. For example, as a substitute or supplement to the detections of operations 402 and/or 406 and the criteria of operation 404 and/or 408, the velocity of the user can be detected and applied to determine whether further operations are to be performed (e.g., providing an output). Where the user is moving slowly (e.g., below a threshold velocity), an output that would otherwise be provided (e.g., if the detected velocity were above the threshold velocity or another threshold) can be omitted.

By further example, as a substitute or supplement to the detections of operations 402 and/or 406 and the criteria of operation 404 and/or 408, the position and/or orientation of the user can be applied to determine whether further operations are to be performed (e.g., providing an output). Where the user is in a particular position and/or orientation (e.g., below a threshold angle with respect to the environment and/or another body portion), an output that would otherwise be provided (e.g., if the angle were above the threshold angle or another threshold) can be omitted.

By further example, as a substitute or supplement to the detections of operations 402 and/or 406 and the criteria of operation 404 and/or 408, the eye gaze direction of the user can be detected and applied to determine whether further operations are to be performed (e.g., providing an output). Where an output includes a view of a virtual feature and the user is gazing in a particular direction and/or at a particular feature (e.g., the virtual feature), it can be inferred that the user is giving attention to that region, and an intent to interact with virtual features in that region can be inferred. As such an output to guide the user can be provided, for example where other detections and criteria so indicate. Where an output includes a view of a physical features and the user is gazing in a particular direction and/or at a particular feature (e.g., the physical feature), it can be inferred that the user is giving attention to that region, and an awareness of the physical feature in that region can be inferred. As such an output to guide the user can be provided, for example at least until another detected condition changes.

By further example, as a substitute or supplement to the detections of operations 402 and/or 406 and the criteria of operation 404 and/or 408, a detected user activity (e.g., gesture, sound, or other user input) can be detected and applied to determine whether further operations are to be performed (e.g., providing an output). Where the user makes a sound (e.g., speech or other vocal output) or gesture that is detected to be above a threshold or have another target characteristic, the output can be provided.

It will be understood that, in some embodiments, additional criteria and/or other criteria are not required. For example, the detections of operation 402 and the criteria of operation 404 can be sufficient to determine that an output is to be provided.

In some embodiments, a user profile can be applied. In operation 410, a user profile can be applied to determine whether a given operation is to be performed. For example, a user profile associated with a given user can be applied to determine whether an operation is appropriate given the user's level of experience, knowledge, preferences, and/or historical activity.

In operation 412, detections in preceding operations and/or proposed operations (e.g., outputs) in response can be compared to criteria to determine whether the proposed operations are to be performed. The user profile can set criteria for providing outputs under only certain conditions. For example, a given user can have a higher level of experience, knowledge, preferences, and/or historical activity such that outputs to guide other users would be omitted and/or overridden for the given user. By further example, a given user can have a lower level of experience, knowledge, preferences, and/or historical activity such that outputs are determined to be appropriate to guide the given user in response to the detected conditions. If the detected condition does not meet the criteria, then a further response may be omitted and/or additional detections can be made by returning to operation 402 or 406.

Additionally or alternatively, the profile can be applied by setting and/or adjusting the criteria of other operations (e.g., operations 404 and/or 408). For example, the profile can be applied prior to the application of one or more criteria. Such an application can be performed when the user begins operation of the head-mountable device. The user can be identified and the corresponding user profile can be loaded to set the criteria, optionally before detections are made. As such, the user-specific criteria can be readily applied when the detections are made.

It will be understood that, in some embodiments, application of a user profile is not required. For example, the detections of operations 402 and 406 and the criteria of operation 404 and 408 can be sufficient to determine that an output is to be provided.

In operation 414, the head-mountable device provides one or more outputs to the user, as described further herein. Such outputs can be provided to guide the user's response to conditions that are detected by the head-mountable device and/or to verify that the user is alert and/or aware of the detected conditions. Further operations by the head-mountable device can include detecting conditions in operation 402 or 406 to determine whether or not a previously detected condition remains.

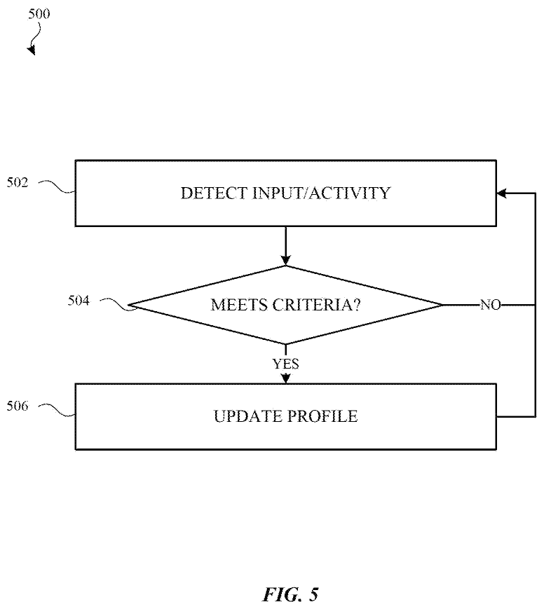

FIG. 5 illustrates a flow diagram of an example process for operating a head-mountable device to manage a profile of a user, according to some embodiments of the present disclosure. For explanatory purposes, the process 500 is primarily described herein with reference to the head-mountable device 100 of FIGS. 2 and 3. However, the process 500 is not limited to the head-mountable device 100 of FIGS. 2 and 3, and one or more blocks (or operations) of the process 500 may be performed by one or more other components or chips of the head-mountable device 100 and/or another device (e.g., external device 200). The head-mountable device 100 also is presented as an exemplary device and the operations described herein may be performed by any suitable device. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

In operation 502, a head-mountable device can detect an input or other activity of a user. Such detections can be performed by one or more user input devices, sensors, or processors of the head-mountable device. In operation 504, detections made by one or more user sensors can be compared to criteria to determine whether the user profile is to be updated. If the detected input or other activity satisfies the criteria, the user profile can be updated in operation 506. If the detected input or other activity does not satisfy the criteria, the user profile can remain the same and/or the head-mountable device can continue to monitor for additional detections of input or other activities.

In some embodiments, the user can provide an input command by operating an input device of the head-mountable device. The operation of the input device can correspond to selections made with a user interface of the head-mountable device. For example, the head-mountable device can provide a menu of options and/or other user-selectable settings that correspond to how and under what conditions the head-mountable device provides outputs. Such selections can include permitting all outputs, permitting some outputs, preventing some outputs, and preventing all outputs that are in response to detected conditions. By further example, the user can select the criteria that is applied to detected conditions and upon which a determination is made whether to provide an output.

In some embodiments, the head-mountable device can detect user activity to determine a user profile. For example, when a user has operated the head-mountable device for a duration that exceeds a threshold, the user profile can be updated to indicate that the user has at least a certain level of experience and familiarity with the operation of the head-mountable device. The tracking of such an operation can optionally be limited to time in which the head-mountable device is operated to output a computer-generated reality, such as including at least one virtual feature. By further example, the head-mountable device can provide a training program (e.g., tutorial) or other operation that helps the user become familiar with the computer-generated reality and the output of one or more virtual features. Upon completion of the training program, the user profile can be updated to indicate that the corresponding user has completed the training program. Thereafter, certain outputs can be omitted and/or the criteria for analyzing detected conditions can be adjusted, as discussed herein.

It will be understood that the process 500 of FIG. 5 can be performed prior to, in parallel with, and/or after the process 400 of FIG. 4. The operations and/or results of either process can initiate and/or alter the operations of the other.

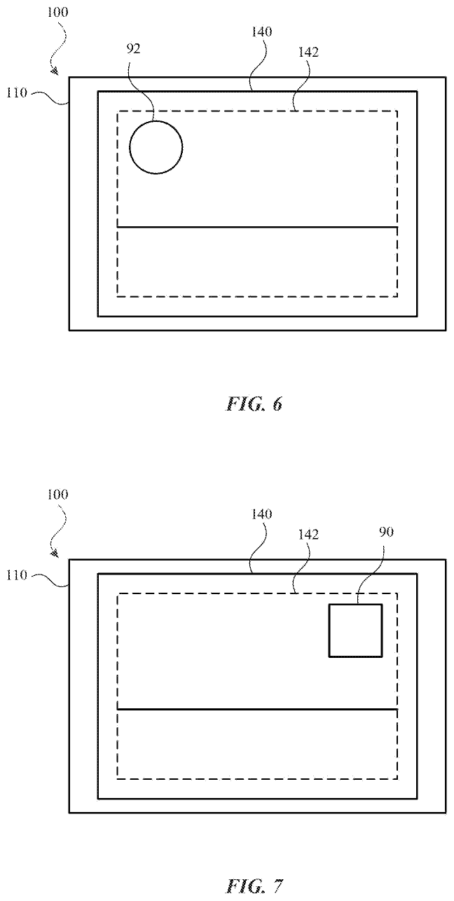

Referring now to FIGS. 6-10, a head-mountable device can be operated to provide one or more of a variety of outputs to the user based on and/or in response to detected conditions. It will be understood that, while the head-mountable devices are depicted separately with different components, more than one output can be provided by any given head-mountable device. As such, the features of different head-mountable devices depicted and described herein can be combined together such that more than one mechanism can be provided with any given head-mountable device.

FIG. 6 illustrates a view of a head-mountable device providing a user interface, according to some embodiments of the present disclosure. For this or any user interface depicted or described herein, not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

The head-mountable device 100 can further include one or more output devices, such as a display 140, for outputting information to the user. Such outputs can be based on the detections of the sensors (e.g., camera 130) and/or other content generated by the head-mountable device. For example, the output of the display 140 can provide a user interface 142 that outputs one or more elements of a computer-generated reality, for example including a virtual feature 92. Such elements can be provided in addition to or without a view of a physical feature of a physical environment, for example within a field of view of the camera. The user interface 142 can further include any other content generated by the head-mountable device 100 as output, such as notifications, messages, text, images, display features, websites, app features, and the like. It will be understood that such content can be displayed visually and/or otherwise output as sound, and the like.

Referring now to FIG. 7, an output of a user interface can change in response to detections performed by the head-mountable device. For example, as shown in FIG. 7, the output of the display 140 can include a view of one or more physical features 90 captured in a physical environment. The display 140 can provide a user interface 142 that outputs the view captured by a camera, for example including a physical feature 90 within a field of view of the camera. The output of the user interface 142 provided by the display can omit, exclude, or be provided without the view of the virtual feature 92. Additionally or alternatively, the user interface 142 can further include any content generated by the head-mountable device 100 as output, such as notifications, messages, text, images, display features, websites, app features, and the like.

In some embodiments, the output (e.g., including the physical feature 90 and optionally excluding the virtual feature 92) can be provided to prompt a behavior from the user. Such a behavior can include a change in position, orientation, distance, and/or movement (e.g., with respect to the physical feature 90 and/or the virtual feature 92) and the like. The output can be provided until the desired behavior is detected.

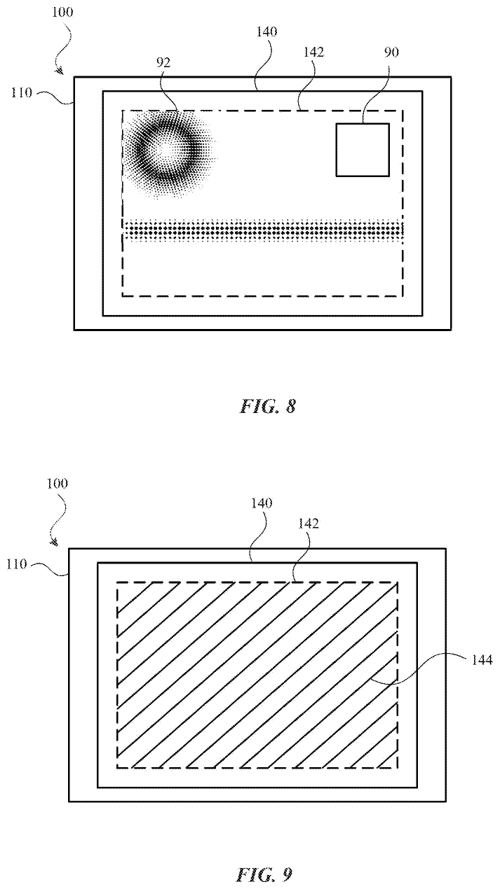

Referring now to FIG. 8, a head-mountable device can be operated to provide another type of visual output that encourages a behavior from the user. As shown in FIG. 8, a virtual feature 92 or other visual feature can be modified as an output to prompt a behavior from the user. For example, the virtual feature 92 can be altered to appear blurred, out of focus or a certain distance away from the user. Such a change can include reducing and/or increasing the noise and/or detail of the virtual feature 92. Such a change can be made with respect to any one or more features displayed by the user interface 142 of the display 140. The aspects of the virtual feature 92 can encourage the user to change the way in which it interacts with the virtual feature 92. For example, the virtual feature 92 can prompt the user to move to resolve the observation of the virtual feature 92. In some embodiments, such visual modifications need not be applied with respect to the output of physical features 90.

In some embodiments, the output can include an additive feature included with the virtual feature 92. For example, a visual feature can include highlighting, glow, shadow, reflection, outline, border, text, icons, symbols, emphasis, duplication, aura, and/or animation provided with the view of the virtual feature 92. Such a visual feature can be provided optionally without altering the appearance of the virtual feature 92. For example, the visual feature can be provided about an outer periphery of the virtual feature 92. Additionally or alternatively, the visual feature can be provided with partial or entire overlap (e.g., overlaid) with respect to the virtual feature 92.

In some embodiments, a visual feature can alter an appearance of a virtual feature 92 itself. For example, a visual feature can be provided as a deformation of the virtual feature 92 from an initial shape. For example, as a user approaches and/or comes into contact with a virtual feature 92, the virtual feature 92 can deform on a side near the user.

In some embodiments, a visual feature can alter a visibility of a virtual feature 92. For example, a virtual feature 92 can be depicted as partially or entirely transparent (e.g., with reduced opacity). Such a visual feature can be provided, for example, as a user approaches the virtual feature 92 and/or as the virtual feature 92 approaches a user. Additionally or alternatively, the visual feature can include other changes to the appearance of the virtual feature 92. For example, the visual feature can include a change to the brightness, darkness, contrast, color, saturation, sharpness, blur, resolution, and/or pixilation of the virtual feature 92.

In some embodiments, a visual feature can alter a characteristic of a virtual feature 92. For example, a virtual feature 92 can be provided with a visual feature that alters the size of the virtual feature 92. Additionally or alternatively, the visual feature can alter other characteristics of the virtual feature 92, such as shape, aspect ratio, position, orientation, and the like.

Referring now to FIG. 9, an output of a user interface can change in response to detections performed by the head-mountable device. For example, as shown in FIG. 9, one or more visual features 144 can be provided within the user interface 142 and is output by the display 140. Such visual features 144 can include any change in the visual output of the display 140 that is perceivable by the user.

For example, the visual feature 144 can have a distinct appearance, brightness, contrast, color, hue, and the like. By further example, the visual feature 144 can include an animation that progresses over time to change its appearance, brightness, contrast, color, hue, and the like. One or more visual features can have a brightness that is greater than a brightness of the user interface 142 prior to the output of the visual feature 144. The aspects of the visual feature 144 can encourage the user to respond with a desired behavior.

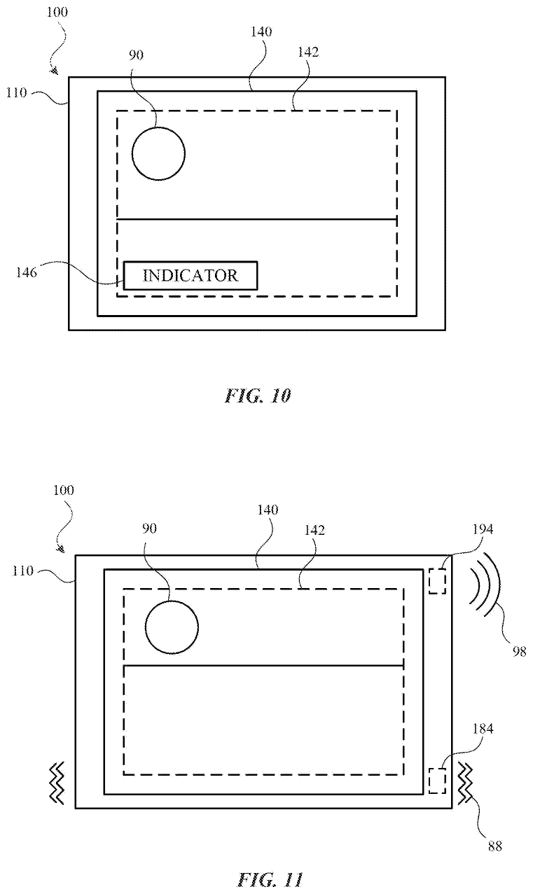

Referring now to FIG. 10, a head-mountable device can provide an indicator to a user to instruct the user to perform certain actions. For example, as shown in FIG. 10, an indicator 146 can be provided within the user interface 142 of the display 140. The indicator 146 can include an instruction for the user to perform, such as movement and the like. Such actions can be understood to allow the user to address a condition that is detected by the head-mountable device 100, such as a condition of the environment, the user, and/or the head-mountable device. The indicator 146 can be consciously understood by the user to provide an opportunity for voluntary act. It will be understood that such indicators can be provided as a visual feature and/or by other mechanisms, such as sound, haptic feedback, and the like.

Referring now to FIG. 11, other components of the head-mountable device 100 can provide one or more other output(s) that encourage a behavior from the user. For example, the head-mountable device 100 can include a speaker 194 for providing audio output 98 (e.g., sound) to a user. One or more sounds can have a volume level (e.g., in decibels) that is greater than a volume level of an audio output provided prior to the output of the sounds. The sound can cause the user to consciously or subconsciously react to a detected condition. By further example, the head-mountable device 100 can include a haptic feedback device 184 for providing haptic feedback 88 to a user. The haptic feedback 88 can cause the user to consciously or subconsciously react to a detected condition.

Additionally or alternatively, it will be understood that a variety of other outputs can be provided to the user. Such outputs can include smells, tactile sensations, and the like.

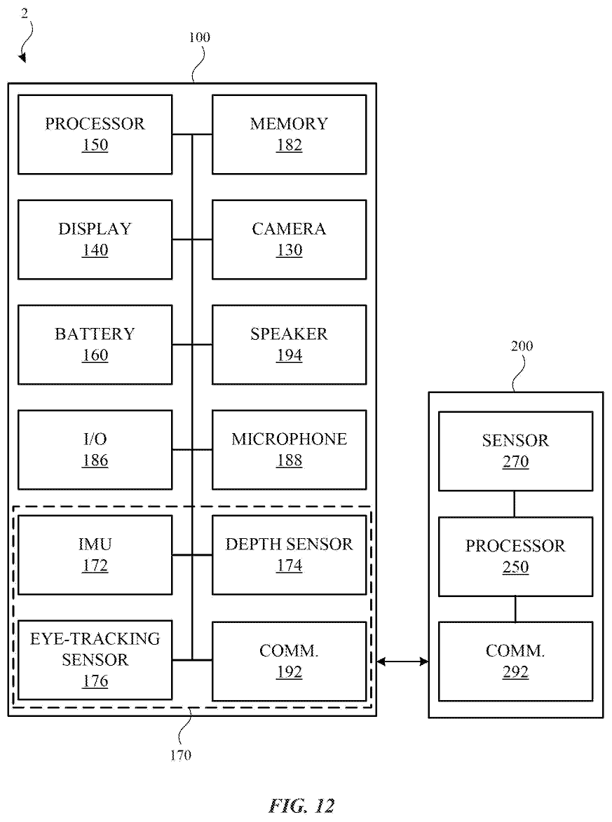

Referring now to FIG. 12, components of the head-mountable device can be operably connected to provide the performance described herein. FIG. 12 shows a simplified block diagram of an illustrative head-mountable device 100 in accordance with one embodiment of the invention. It will be appreciated that components described herein can be provided on one, some, or all of a frame, a head engager, and the like. It will be understood that additional components, different components, or fewer components than those illustrated may be utilized within the scope of the subject disclosure.

As shown in FIG. 12, the head-mountable device 100 can include a processor 150 (e.g., control circuity) with one or more processing units that include or are configured to access a memory 182 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a processor, a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100. For example, the memory 182 can store electrical data or content such as, for example, user profiles, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual features into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can include a battery 160, which can charge and/or power components of the head-mountable device 100. The battery 160 can also charge and/or power components connected to the head-mountable device 100.

The head-mountable device 100 can include the microphone 188 as described herein. The microphone 188 can be operably connected to the processor 150 for detection of sound levels and communication of detections for further processing, as described further herein.

The head-mountable device 100 can include the speakers 194 as described herein. The speakers 194 can be operably connected to the processor 150 for control of speaker output, including sound levels, as described further herein.

The head-mountable device 100 can include an input/output device 186, which can include any suitable component for receiving input from a user, including buttons, keys, body sensors, gesture detection devices, microphones, and the like. It will be understood that the input/output device 186 can be, include, or be connected to another device, such as a keyboard, mouse, stylus, and the like. The input/output device 186 can include one or more output devices, such as displays, speakers, haptic feedback devices, and the like. It will be understood that the input/output device 186 can include separate components as input device(s) and output device(s).

The eye-tracking sensor 176 can track features of the user wearing the head-mountable device 100, including conditions of the user's eye (e.g., focal distance, pupil size, etc.). For example, an eye sensor can optically capture a view of an eye (e.g., pupil) and determine a direction of a gaze of the user. Such eye tracking may be used to determine a location and/or direction of interest with respect to the display 140 and/or elements presented thereon. User interface elements can then be provided on the display 140 based on this information, for example in a region along the direction of the user's gaze or a region other than the current gaze direction, as described further herein. The detections made by the eye-tracking sensor 176 can determine user actions that are interpreted as user inputs. Such user inputs can be used alone or in combination with other user inputs to perform certain actions. By further example, such sensors can perform facial feature detection, facial movement detection, facial recognition, user mood detection, user emotion detection, voice detection, and the like.

The head-mountable device 100 can include one or more other sensors. Such sensors can be configured to sense any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics.

The head-mountable device 100 can include an inertial measurement unit 172 (“IMU”) that provides information regarding a characteristic of the head-mounted device, such as inertial angles thereof. For example, the IMU can include a six-degrees of freedom IMU that calculates the head-mounted device's position, velocity, and/or acceleration based on six degrees of freedom (x, y, z, θx, θy, and θz). The IMU can include one or more of an accelerometer, a gyroscope, and/or a magnetometer. Additionally or alternatively, the head-mounted device can detect motion characteristics of the head-mounted device with one or more other motion sensors, such as an accelerometer, a gyroscope, a global positioning sensor, a tilt sensor, and so on for detecting movement and acceleration of the head-mounted device.

The head-mountable device 100 can include image sensors, depth sensors 174, thermal (e.g., infrared) sensors, and the like. By further example, a depth sensor 174 can be configured to measure a distance (e.g., range) to a feature (e.g., region of the user's face) via stereo triangulation, structured light, time-of-flight, interferometry, and the like. Additionally or alternatively, a face sensor and/or the device can capture and/or process an image based on one or more of hue space, brightness, color space, luminosity, and the like.

The head-mountable device 100 can include a communication element 192 for communicating with one or more servers or other devices using any suitable communications protocol. For example, communication element 192 can support Wi-Fi (e.g., a 802.11 protocol), Ethernet, Bluetooth, high frequency systems (e.g., 1400 MHZ, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communication element 192 can also include an antenna for transmitting and receiving electromagnetic signals.

A system 2 including the head-mountable device 100 can further include an external device 200. The external device 200 can facilitate posture detection and operate in concert with the head-mountable device 100, as described herein.

The external device 200 can include a processor 250 (e.g., control circuity) with one or more processing units that include or are configured to access a memory having instructions stored thereon. The instructions or computer programs may be configured to perform one or more of the operations or functions described with respect to the external device 200. The processor 250 can be implemented as any electronic device capable of processing, receiving, or transmitting data or instructions. For example, the processor 250 may include one or more of: a processor, a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The external device 200 can include one or more sensors 270 of a posture detection system, as described herein. The posture detection system of the external device 200 can include one or more sensors and/or communication elements. The sensors 270 can include sensors for detecting body portions of the user, the head-mountable device 100, and/or another external device 200. For example, the posture detection system can include an IMU, a depth sensor, and the like.

The external device 200 can include a communication element 292 for communicating with one or more servers or other devices using any suitable communications protocol. For example, communication element 292 can support Wi-Fi (e.g., a 802.11 protocol), Ethernet, Bluetooth, high frequency systems (e.g., 1400 MHZ, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communication element 292 can also include an antenna for transmitting and receiving electromagnetic signals.

Accordingly, embodiments of the present disclosure provide a head-mountable device that can facilitate comfort, guidance, and alertness of the user by providing visual and other outputs with one or more user interface devices. Such outputs can encourage awareness, alertness, and knowledge of the user's movement, features of the environment, and/or the conditions of the user. The actions can be performed by an output of the head-mountable device, such as a display, a speaker, a haptic feedback device, and/or another output device that interacts with the user.

Various examples of aspects of the disclosure are described below as clauses for convenience. These are provided as examples, and do not limit the subject technology.

Clause A: a head-mountable device comprising: a camera configured to capture a view of a physical environment; a display configured to output a view of a computer-generated reality comprising a virtual feature; a sensor configured to detect at least one of a position or motion of a physical feature in the physical environment with respect to a user; and a processor configured to, in response to a detection of the position or motion of the physical feature with respect to the user, operate the display to provide an output comprising the view of the physical environment.

Clause B: a head-mountable device comprising: a camera configured to capture a view of a physical environment comprising a physical feature; a display configured to output a view of a computer-generated reality comprising a virtual feature; a head sensor configured to detect a position of a head; a body sensor configured to detect a position of a body portion; and a processor configured to, in response to at least one of the position of the head or the position of the body portion, operate the display to output the view of the physical environment.

Clause C: a head-mountable device comprising: a camera configured to capture a view of a physical environment; a display configured to output a view of a computer-generated reality comprising a virtual feature; a storage medium for storing a user profile; a sensor configured to detect a physical feature in the physical environment; and a processor configured to, in response to the user profile and a detection of the physical feature, determine whether to operate the display to output the view of the physical environment.

One or more of the above clauses can include one or more of the features described below. It is noted that any of the following clauses may be combined in any combination with each other, and placed into a respective independent clause, e.g., clause A, B, or C.

Clause 1: the output comprises the view of the physical environment without the view of the virtual feature.

Clause 2: the processor is further configured to operate the display to modify a visual feature of the virtual feature.

Clause 3: the processor is further configured to operate the display to modify a brightness of the view of the computer-generated reality.

Clause 4: an eye sensor configured to detect an eye gaze direction of an eye, wherein the processor is configured to operate the display further in response to a detection of the eye gaze direction.

Clause 5: the sensor is further configured to detect a velocity of the user, wherein the processor is further configured to, in response to a detection of the velocity, operate the display to provide the output.

Clause 6: a speaker, wherein the processor is further configured to, in response to the detection of the position or motion of the physical feature with respect to the user, operate the speaker to output a sound.

Clause 7: a haptic feedback device, wherein the processor is further configured to, in response to the detection of the position or motion of the physical feature with respect to the user, operate the haptic feedback device to output haptic feedback.

Clause 8: the head sensor comprises an inertial measurement unit.

Clause 9: the body sensor comprises a depth sensor configured to detect the body portion.

Clause 10: the body sensor comprises an additional camera configured to capture a view of the body portion.

Clause 11: the at least one of the position of the head or the position of the body portion comprises a change of an angle formed by the head and the body portion.

Clause 12: the output comprises the view of the physical environment without the view of the virtual feature.

Clause 13: the processor is further configured to determine whether to operate the display to output the view of the physical environment without the view of the virtual feature.

Clause 14: the user profile contains a record of an amount of time outputting the view of the computer-generated reality for a user corresponding to the user profile.

Clause 15: the user profile contains a record of a selection by a user corresponding to the user profile.

Clause 16: the user profile contains a criteria; and the processor is further configured to compare the detection of the physical feature to the criteria.

Clause 17: an input device operable to change the user profile.

As described above, one aspect of the present technology may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A head-mountable device comprising:
a camera configured to capture a view of a physical environment;
a display configured to output a view of a computer-generated reality comprising a virtual feature;
a sensor configured to detect at least one of a position or motion of a physical feature in the physical environment with respect to a user; and
a processor configured to, in response to a detection of the position or motion of the physical feature with respect to the user, operate the display to provide an output comprising an indication of the physical feature.

2. The head-mountable device of claim 1, wherein the output comprises the view of the physical environment without the view of the virtual feature.

3. The head-mountable device of claim 1, wherein the processor is further configured to operate the display to modify a visual feature of the virtual feature.

4. The head-mountable device of claim 1, wherein the processor is further configured to operate the display to modify a brightness of the view of the computer-generated reality.

5. The head-mountable device of claim 1, further comprising an eye sensor configured to detect an eye gaze direction of an eye, wherein the processor is configured to operate the display further in response to a detection of the eye gaze direction.

6. The head-mountable device of claim 1, wherein the sensor is further configured to detect a velocity of the user, wherein the processor is further configured to, in response to a detection of the velocity, operate the display to provide the output.

7. The head-mountable device of claim 1, further comprising a speaker, wherein the processor is further configured to, in response to the detection of the position or motion of the physical feature with respect to the user, operate the speaker to output a sound.

8. The head-mountable device of claim 1, further comprising a haptic feedback device, wherein the processor is further configured to, in response to the detection of the position or motion of the physical feature with respect to the user, operate the haptic feedback device to output haptic feedback.

9. A head-mountable device comprising:
a camera configured to capture a view of a physical environment comprising a physical feature;
a display configured to output a view of a computer-generated reality comprising a virtual feature;
a head sensor configured to detect a position of a head;
a body sensor configured to detect a position of a body portion; and
a processor configured to, in response to at least one of the position of the head or the position of the body portion, operate the display to output an indication of the physical feature.

10. The head-mountable device of claim 9, wherein the head sensor comprises an inertial measurement unit.

11. The head-mountable device of claim 9, wherein the body sensor comprises a depth sensor configured to detect the body portion.

12. The head-mountable device of claim 9, wherein the body sensor comprises an additional camera configured to capture a view of the body portion.

13. The head-mountable device of claim 9, wherein the at least one of the position of the head or the position of the body portion comprises a change of an angle formed by the head and the body portion.

14. The head-mountable device of claim 9, wherein the output comprises the view of the physical environment without the view of the virtual feature.

15. A head-mountable device comprising:
a camera configured to capture a view of a physical environment;
a display configured to output a view of a computer-generated reality comprising a virtual feature;
a storage medium for storing a user profile;
a sensor configured to detect a physical feature in the physical environment; and
a processor configured to, in response to the user profile and a detection of the physical feature, determine whether to operate the display to output an indication of the physical feature.

16. The head-mountable device of claim 15, wherein the processor is further configured to determine whether to operate the display to output the view of the physical environment without the view of the virtual feature.

17. The head-mountable device of claim 15, wherein the user profile contains a record of an amount of time outputting the view of the computer-generated reality for a user corresponding to the user profile.

18. The head-mountable device of claim 15, wherein the user profile contains a record of a selection by a user corresponding to the user profile.

19. The head-mountable device of claim 15, wherein:
the user profile contains a criteria; and
the processor is further configured to compare the detection of the physical feature to the criteria.

20. The head-mountable device of claim 15, further comprising an input device operable to change the user profile.
